(19) United States
(12) Patent Application Publication
(10) Pub. No.: US 2019/0171761 A1
(43) Pub. Date: Jun. 6, 2019

(54) Using Hierarchical Correlation Information To Signify Hierarchical Structure In A Single-Dimensional Stream

(71) Applicant: Microsoft Technology Licensing, LLC, Redmond, WA (US)

(72) Inventors: Peter G. SALAS, Seattle, WA (US); Bogdan BRINZA, Seattle, WA (US); Rossen ATANASSOV, Bellevue, WA (US)

(21) Appl. No.: 15/830,764

(22) Filed: Dec. 4, 2017

(51) Int. Cl. G06F 17/30

(52) U.S. Cl. CPC G06F 17/30769; G06F 17/30743; G06F 17/30867

(57) ABSTRACT

A device receives a request for output in a single dimension. A query to perform for the request is generated that includes values. The single-dimensional stream of data is generated from multidimensional data. The device accesses a hierarchical correlation information data structure using the query to determine hierarchical correlation information associated with the values and uses hierarchical structure from the hierarchical correlation information to generate a response that includes a portion of the single-dimensional stream of data. The hierarchical correlation information signifies hierarchical structure with respect to the portion of the single-dimensional stream of data. The device then outputs the portion of the single-dimensional stream of data in the single dimension.

### BACKGROUND

Users may use devices that may output content in which hierarchical structure information for the content may be lost. For example, smart speakers, smart watches, or car output systems may output content in a single dimension, such as via audio. The content that a smart speaker may use to generate a response to a user query may originate from multi-dimensional data, such as from a website that may include content that is output in two dimensions (e.g., the height and width dimensions) in a visual display. The content may include a hierarchical structure that defines how to output the content in the multi-dimensions. Because the smart speaker outputs information in a single dimension, the hierarchical structure information may be lost when being processed by the smart speaker.

In some examples, if there is a hierarchical list of two items, the smart speaker may parse the list and produce a single-dimensional stream that speaks the characters for the names of the two items, such as a single-dimensional stream that outputs “item 1 item 2” audibly. However, the smart speaker does not know that item 1 and item 2 are items in a list because the hierarchical structure information may not be received from the original content of the website. For example, some markers that define the hierarchical structure of the list are removed in the data that the smart speaker receives and uses to generate the audio output. Thus, using the single-dimensional stream, the smart speaker is limited in the responses that can be provided to a user compared to the output generated by a website.

### BRIEF DESCRIPTION OF THE DRAWINGS

FIG. 1 depicts a simplified system for providing output using a single-dimensional stream according to some embodiment.

FIG. 2A depicts an example of multi-dimensional output according to some embodiments.

FIG. 2B depicts an example of multi-dimensional data according to some embodiments.

FIG. 3A depicts an example of the hierarchical correlation information applied to a multi-dimensional data according to some embodiments.

FIG. 3B depicts an example of the single-dimensional stream that is stored in a single-dimensional stream data structure according to some embodiments.

FIG. 3C depicts an example of the hierarchical correlation information in a hierarchical information data structure according to some embodiments.

FIG. 4 depicts a simplified flowchart of a method of assigning hierarchical correlation information according to some embodiments.

FIG. 5 depicts a simplified flowchart of a method for processing requests according to some embodiments.

FIG. 6 depicts a more detailed example of an output device according to some embodiments.

FIG. 7 depicts a simplified block diagram of an example computer system according to certain embodiments.

### DETAILED DESCRIPTION

An output device may output information, such as in a single dimension through audio. The output device may use a single-dimensional stream of data that is generated from multi-dimensional data to output the information. The multi-dimensional data may include hierarchical structure information that defines a hierarchical structure of the data and is used to render the multi-dimensional data in multiple dimensions. For example, the multi-dimensional data may include markers that define hierarchical structures, such as a hierarchical list or drop down menu. The hierarchical structure information is not rendered, but is used to signify hierarchical structure for objects that are output. As discussed in the Background, only the objects may be used to output information in the single dimension and in some cases only the objects are sent to the output device. However, instead of sending just the objects as described in the Background, the output device receives multi-dimensional data that includes the hierarchical structure information with the objects.

The output device can parse the multi-dimensional data and generate a single-dimensional stream of data that may include the objects that can be output and also the markers that define the hierarchical structure. Also, the output device generates hierarchical correlation information that may represent the hierarchical structure for the single-dimensional stream of data. For example, the output device can parse markers (e.g., HyperText Transfer Markup Language (HTML) markers) in the multi-dimensional data and determine the hierarchical correlation information based on the markers and objects encountered. As will be described in more detail below, the output device may assign integer numbers to objects in the single-dimensional stream of data and fractional numbers to hierarchical structure information in the single-dimensional stream of data. The output device then stores the hierarchical correlation information and the single-dimensional stream of data.

When the output device receives a request for output, such as a user may send a request to the output device for information, the output device can generate a query to access the single-dimensional data. The query may follow a specification for an application programming interface (API) that is used to query the single-dimensional stream of data. In some embodiments, the API may specify that ranges of values be used to query the single-dimensional stream of data, such as the query may ask for a range of integers values that are associated with portions of the single-dimensional stream of data. For example, characters of the objects may be assigned integer numbers, such as each letter of the object “item 1” may be assigned the integers of 1-5. The query for the range [1, 5] would then retrieve the object “item 1”.

The use of the hierarchical correlation information allows the output device to interpret hierarchical structure for the single-dimensional stream of data. For example, the output device can traverse the single-dimensional stream of data with respect to the hierarchical structure using the hierarchical correlation information, such as by navigating the hierarchy of a list, and then output portions of the list with reference to the hierarchy. For example, the output device can not only output to a user the words “item 1” and “item 2”, but also indicate that item 1 and item 2 are part of a list based on the hierarchical correlation information. This improves the output that output device can generate by allowing the output device to provide output that indicates hierarchical structure while using the single-dimensional stream. In contrast to the Background section, the output device without using the hierarchical correlation information would only be able to output the words item 1 and item 2 without knowing that item 1 and item 2 are part of the hierarchy of a list. Also, the output device can parse the single-dimensional stream in an improved manner using the hierarchical correlation information, such as by performing actions not possible as described in the Background. For example, hierarchical navigation of the single-dimensional stream using the hierarchical correlation information can be performed. This technically extends the navigation that output device can perform and the type of response that output can generate.

### System Overview

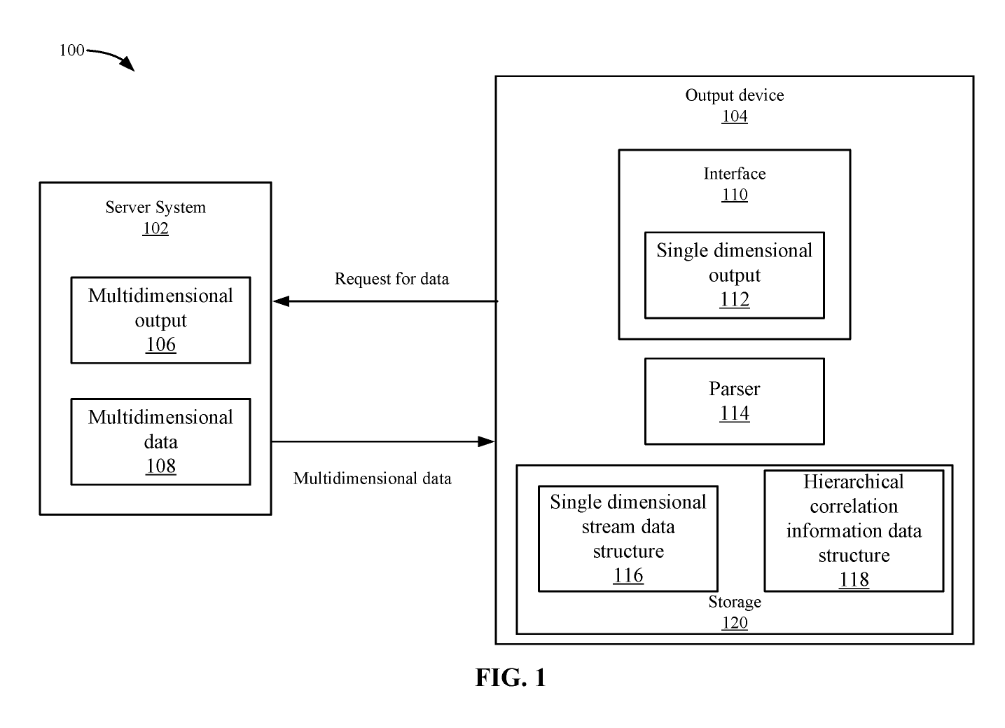

FIG. 1 depicts a simplified system 100 for providing output using a single-dimensional stream according to some embodiment. Server system 102 may include multi-dimensional data 108, such as data that is rendered in two-dimensions or three-dimensions. The multi-dimensional data may include hierarchical structure information that allows objects in the data to be output in multiple dimensions in multi-dimensional output 106, such as a website that may output the objects in the height and width dimensions. For example, the hierarchical structure information may define which items are part of a list or drop down menu, when to insert line breaks to the output, etc. Although multi-dimensional output 106 is shown as being output by server system 102, it will be understood that other systems may output multi-dimensional output 106 using multi-dimensional data 108.

In some embodiments, the hierarchical structure information may organize objects in multi-dimensional data 108 in a hierarchical structure, such as a tree structure. The objects of the multi-dimensional data 108 may be content that may be output, such as the names for items in a list. The hierarchical structure information may define hierarchical structure for the output and is not output, such as either visually or audibly. In some embodiments, the hierarchical structure information may be included in a document object model (DOM) that organizes nodes in a structure. The nodes are organized in a tree structure referring to as a DOM tree. When a webpage is rendered by a browser, the document object model of the page may be used to output the webpage in two dimensions. The document object model may include hierarchical markers that represent the hierarchical structure information of the document. A marker may be text that identifies hierarchical structure associate with one or more objects. In some examples, the hierarchical structure information may define a list of items where the list may be the top-level element, and items may be distributed hierarchically in the list.

Output device 104 may include an interface 110 that can output single-dimensional output 112. In some examples, interface 110 may include a speaker that outputs audio. Although a single dimension is described, it will be understood that output device 104 may output information from the single-dimensional stream of data in multiple dimensions, such as in text. However, output device 104 interprets the single-dimensional stream of data to generate the output in multiple dimensions.

Output device 104 can send a request for multi-dimensional data 108 to server system 102. In some embodiments, output device 104 may send a request for a webpage. Server system 102 may then send the multi-dimensional data 108 to output device 104. For example, server system 102 may send multi-dimensional data 108 in different ways. In some embodiments, multi-dimensional data 108 may include the hierarchical markers that represent the hierarchical structure, such as the markers in the document object model, and the objects. For example, server system 102 may send text for the markers and objects in a stream of characters to output device 104.

A parser 114 receives multi-dimensional data 108 and can then parse the stream to generate a single-dimensional stream that can be used to output single-dimensional output 112. For example, the single-dimensional stream may be a stream of characters that includes the objects and the markers. Also, in some examples, parser 114 may separate the objects and markers into different data structures. Parser 114 stores the single-dimensional stream in a single-dimensional stream data structure 116 in storage 120.

During the parsing, parser 114 can determine certain hierarchical markers that are included in multi-dimensional data 108. Parser 114 can then determine the hierarchical correlation information for the hierarchical markers and the objects in the single-dimensional stream and store the hierarchical correlation information in a hierarchical information data structure 118 in storage 120. Although two different data structures are described for the single-dimensional stream and the hierarchical correlation information, it will be understood that other data structures may be used, such as using a single data structure.

Output device 104 can then use the hierarchical correlation information and the single-dimensional stream to generate single-dimensional output 112. In some embodiments, output device 104 can traverse the single-dimensional stream using the hierarchical correlation information and/or retrieve objects from the single-dimensional stream. For example, output device 104 can move forward or backward in a list, or step in or step out of different levels of the hierarchy using the hierarchical correlation information. Also, output device 104 can retrieve objects, such as the children of an object. Then, interface 110 can output the objects found in the single-dimensional stream with reference to the hierarchical structure determined from the hierarchical correlation information. For example, interface 110 can receive a request for a list of items and then output that the list of items includes item 1 and item 2. In this example, not only can output device 104 audibly output item 1 and item 2, but output device 104 may add hierarchical information, such as stating that item 1 and item 2 are part of a list. This may allow a user to perform further requests, such as retrieve children of item 1 or item 2. Output device 104 can then also determine any children that are related to item 1 or item 2 using the hierarchical correlation information.

Multi-Dimensional Output and Multi-Dimensional Data

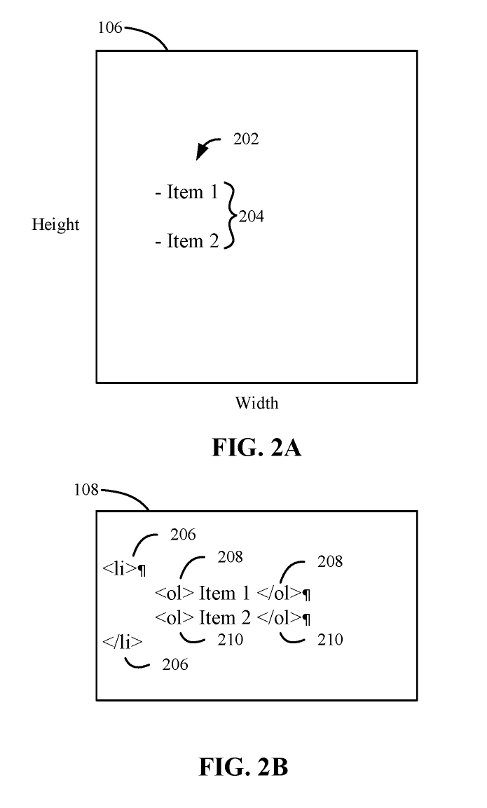

FIG. 2A depicts an example of multi-dimensional output 106 and FIG. 2B depicts an example of multi-dimensional data 108 according to some embodiments. In FIG. 2A, multi-dimensional output 106 may be output using a height dimension and a width dimension. For example, a webpage may include a height and width. The webpage renders a list at 202 using the height and width dimensions. The list may include two items of Item 1 and Item 2 that are placed in the list. The list includes objects of “Item 1” and “Item 2” shown at 204. Other sub-items under Item 1 and Item 2 may also be appreciated, but are not shown.

In FIG. 2B, multi-dimensional data 108 includes hierarchical markers in addition to the objects. For example, a list marker at 206 shows the beginning and end of a list. Then, the marker “<ol>” and “</ol>” at 208 shows a marker that defines an ordered list for Item 1. Also, the same markers at 210 define an ordered list for Item 2. The markers shown at 206, 208, and 210 may define a hierarchical structure for the objects Item 1 and Item 2 and are not rendered visually. Server system 102 may use the markers to generate multi-dimensional output 106 in multiple dimensions. For example, server system 102 can format the position of item 1 and item 2 in the height and width dimensions using the hierarchical structure information defined by the markers.

Single-Dimensional Stream

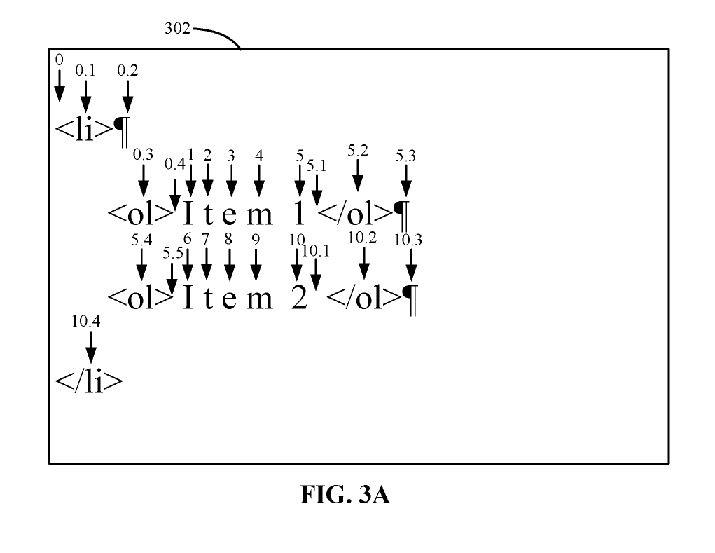

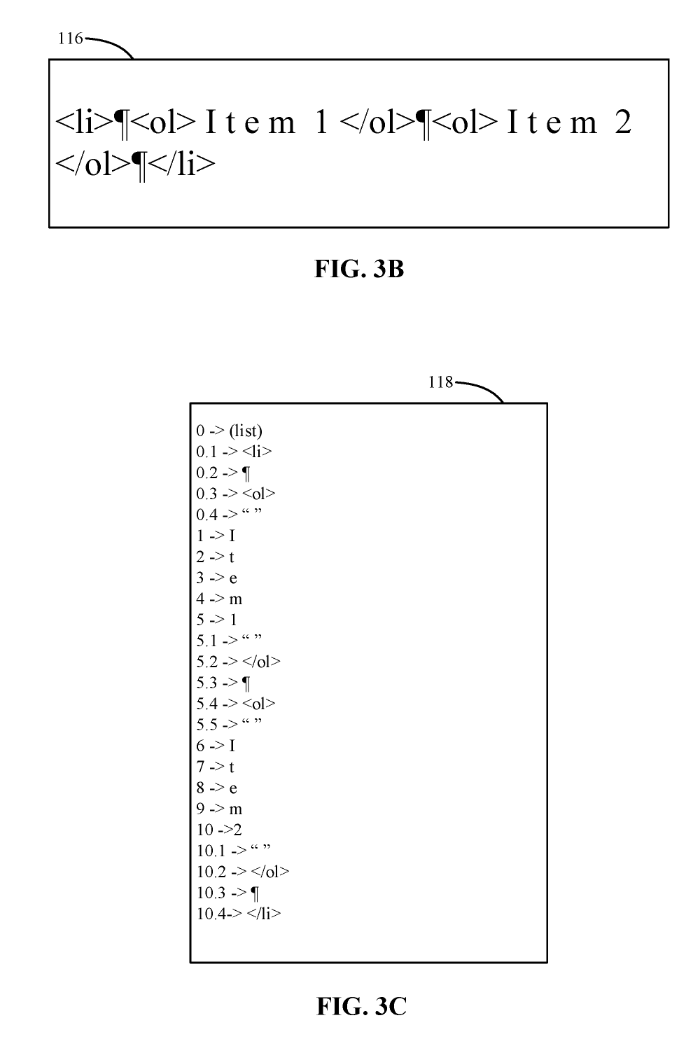

FIG. 3A depicts an example of the hierarchical correlation information applied to a multi-dimensional data 108 according to some embodiments. In some embodiments, the hierarchical correlation information may be in the form of numbers, such as integers and fractions of integers. For example, any portion of an object, such as Item 1, may be associated with an integer number, such as 1, 2, 3, etc. Hierarchical structure may be associated with a fractional number, such as 0.1, 0.2, etc. As discussed above, the application programming interface (API) that output device 104 uses to access the single-dimensional stream uses a range of integer numbers. For example, the API may receive a request from a user and then generate a query with a range of numbers, such as from 0 to 5. The use of the integer numbers follows the API specification and allows output device 104 to continue to use the API.

Parser 114 may parse multi-dimensional data 108 and assign hierarchical correlation information to the data. For example, when parser 114 encounters markers in multi-dimensional data 108 to indicate the hierarchical structure, parser 114 assigns a fractional number to the markers. When parser 114 encounters an object in multi-dimensional data 108, parser 114 assigns an integer value, such as assigning an integer value to each character of an object.

The hierarchical correlation information that is assigned to multi-dimensional data 108 is shown at 302. For example, at the beginning of the list, parser 114 assigns the integer value of 0. Then, a marker of <li> is encountered and parser 114 assigns the fractional value 0.1. Parser 114 determines the fractional value by incrementing the last integer value by a fraction, such as by 0.1. It will be understood that other fractional values may be used. The fractional value of 0.1 may indicate that there is hierarchical information in between the integers of 0 and 1 in the single-dimensional stream of data.

Then, parser 114 encounters a new line marker and parser 114 assigns the new line marker the fractional value of 0.2. Parser 114 then encounters the ordered list marker of “<ol>” and assigns this marker 0.3. Parser 114 encounters a space and assigns the space fractional number 0.4.

Parser 114 then encounters a character of an object in multi-dimensional data 108. For example, the object may be information that can be output as single-dimensional output 112 in contrast to the hierarchical markers, which are not output. Because an object has been encountered, parser 114 then assigns the integer number 1 to the character “I”. Similarly, parser 114 may assign the subsequent characters that are encountered after the character I in “Item 1”, the integer numbers of 2, 3, 4, and 5, respectively.

After parsing the object Item 1, parser 114 encounters additional hierarchical markers. For example, a space, the end of the ordered list marker, and another line break are encountered and parser 114 assigns the fractional numbers 5.1, 5.2, and 5.3, respectively. This indicates that after the integer number 1, additional hierarchical structure information is located in the single-dimensional stream. This ends the hierarchical structure information for Item 1.

For Item 2, parser 114 encounters a marker for the ordered list and a space, and assigns these markers the fractional numbers 5.4 and 5.5. Then, parser 114 encounters the object of Item 2 and can assign the characters of the object the integer numbers of 6, 7, 8, 9, and 10, respectively. After the object of Item 2, parser 114 assigns additional markers the fractional numbers 10.1, 10.2, and 10.3, which ends the ordered list for Item 2. Parser 114 then encounters the end of the list marker and assigns this marker the fractional value of 10.4.

Parser 114 uses the fractional values to signify hierarchical structure in the single-dimensional stream. The hierarchical correlation information can be used to identify the hierarchical position in the single-dimensional stream of data and determine which elements are hierarchical structure information or objects that can be output. Output device 104 can then use the hierarchical structure to traverse the single-dimensional stream or retrieve objects from the single-dimensional stream.

The single-dimensional stream of data and the hierarchical correlation information may be stored in different ways. FIG. 3B depicts an example of the single-dimensional stream that is stored in single-dimensional stream data structure 116 according to some embodiments. As shown, the single-dimensional stream is stored as a stream of characters. For example, the markers and objects are stored as plain text. Although markers are shown in the single-dimensional stream, only the objects may be included. The markers may be stored separately.

To generate output from the single-dimensional stream, output device 104 uses the hierarchical correlation information in hierarchical information data structure 118 to traverse the single-dimensional stream of data. FIG. 3C depicts an example of the hierarchical correlation information in hierarchical information data structure 118 according to some embodiments. Within hierarchical information data structure 118, the hierarchical correlation information of the integers and fractions may be stored with links to the elements of the single-dimensional stream. For example, each integer or fractional number may be associated with a marker or letter of the single-dimensional stream. In some embodiments, hierarchical information data structure 118 may be a list of integers and fractions. The list may link the integers or fractional numbers to entries that include the values from the single-dimensional stream. However, other data structures may be used to link the hierarchical structure information with the single-dimensional stream. For example, the integers and fractional numbers may be keys that include entries of the markers and objects in the single-dimensional stream. A map (e.g., dictionary) of key value pairs corresponding to the index and value of the unit may be used. The integer values as well as children in the ranges can be queried to receive the corresponding values.

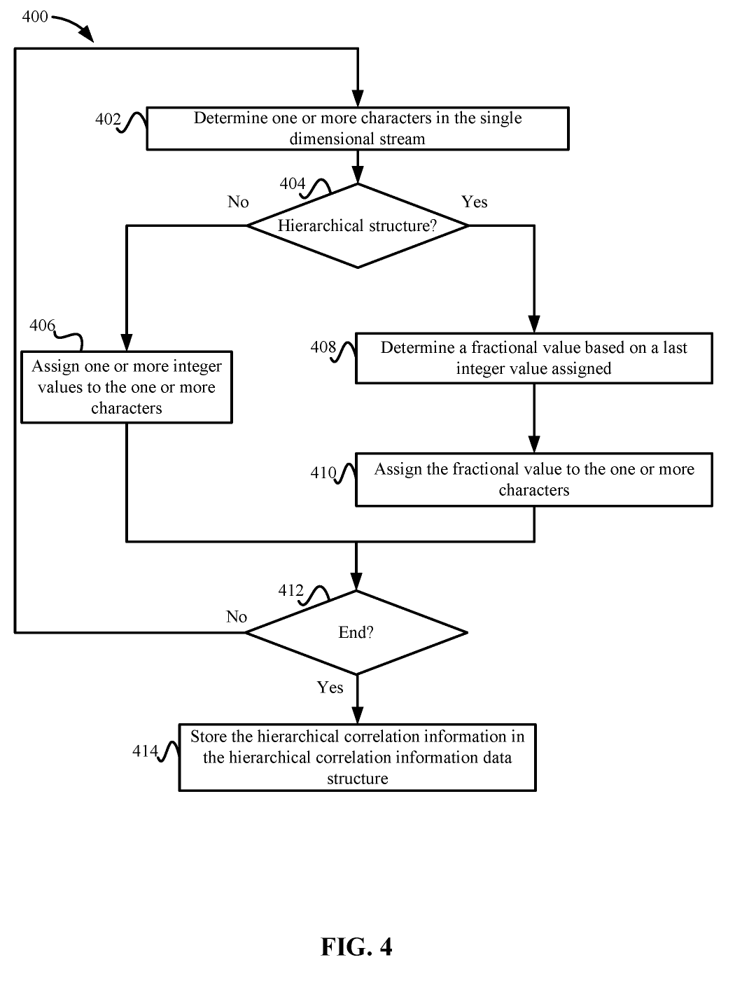

FIG. 4 depicts a simplified flowchart 400 of a method of assigning hierarchical correlation information according to some embodiments. It will be understood that although fractional numbers and integer numbers are assigned, other hierarchical correlation information may be used. For example, characters, symbols, or other information that can define hierarchical structure can be used instead of fractional numbers and integer numbers.

At 402, parser 114 determines one or more characters in multi-dimensional data 108. For example, different symbols or letters are determined. Although characters are described, it will be understood that other types of information may be used, such as the single-dimensional stream may include audio notes, bits, or other information.

At 404, parser 114 determines if the one or more characters are associated with the hierarchical structure. For example, parser 114 may have a list of possible markers that can be included in the single-dimensional stream, such as markers that can be used in a document object model. Parser 114 can compare the one or more characters to the markers to determine if the characters correspond to a marker. For example, parser 114 recognizes hierarchical structure when parser 114 encounters one or more symbols that correspond to the child elements in a state when parser 114 expects hierarchical information. Examples of some symbols in HTML markup language are tag open symbol: “<” or tag close sequence: “/>”. These symbols are using the context of HTML markup language, however, parser 114 could use other information, such as information from other structured markup languages as long as parser 114 can understand the structural information encoded in the document.

If the one or more characters are not associated with the hierarchical structure, then at 406, parser 114 assigns one or more integer values to the one or more characters. For example, a character “I” of Item 1 may be assigned the integer value of “1”, the character “t” may be assigned the integer value of “2”, and so on.

If the one or more characters does correspond to the hierarchical structure, then at 408, parser 114 determines a fractional value based on the last integer value assigned. For example, if the last integer value assigned was “1”, then parser 114 may assign a fractional value of 1.1. Additionally, if the last value assigned was the fractional value of 1.1, then the next fractional value is determined as 1.2.

At 410, parser 114 then assigns the fractional value to the one or more characters. For example, a marker of “<li>” may be assigned one fractional value of 1.1. In other examples, each character of “<li>” may be assigned a fractional number, such as 1.1, 1.2, 1.3, and 1.4 for the four characters of “<li>”.

At 412, parser 114 determines if the end of the single-dimensional stream is reached. If not, the process reiterates to 402 where additional characters are parsed. If the end of the single-dimensional stream is reached, then at 414, parser 114 stores the hierarchical structure information in hierarchical information data structure 118.

Request Processing

Once parser 114 stores the single-dimensional stream and the hierarchical structure information, output device 104 can process requests, such as requests from a user. For example, a request from a user may ask for items in the list or request navigation of items in a list.

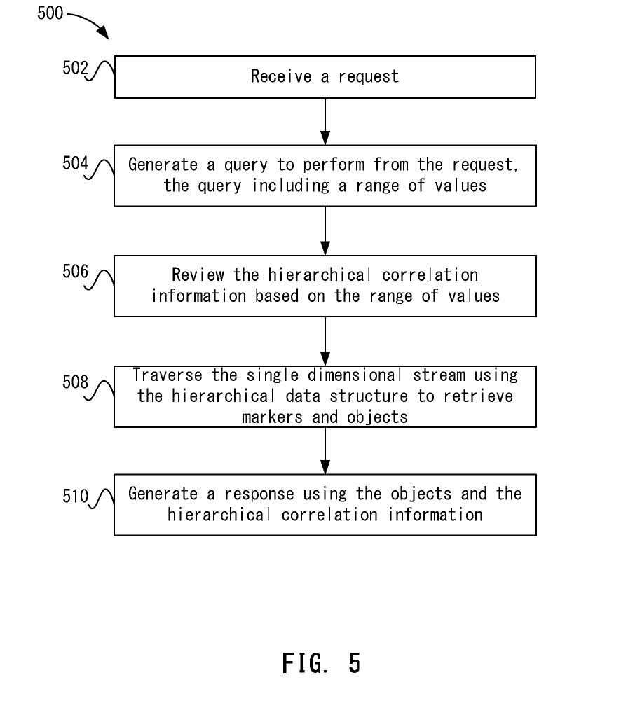

FIG. 5 depicts a simplified flowchart 500 of a method for processing requests according to some embodiments. At 502, output device 104 receives a request, such as a user may input a request, such as speak a request to output device 104. For example, the request may be a request to navigate by a unit, such as a character or word. For example, the request may ask for items of a list. The unit may be different from the range of values in the hierarchical correlation information. In one example, parser 114 may receive the request from an application.

At 504, output device 104 generates a query to perform from the request. For example, the query may include a range of values. In some embodiments, output device 104 may query the single-dimensional stream using only integer values as defined by an API. From the request, output device 104 can generate the query, such as a query may be to retrieve a range of [0,5]. This query indicates that information in the single-dimensional stream that is assigned the numbers from 0 to 5 should be retrieved. Also, the query retrieves any fractional values in between the integer numbers.

At 506, output device 104 reviews the hierarchical correlation information to select the hierarchical correlation information for the query. If there are fractional values, then output device 104 can embed the hierarchical correlation information for the application. Also, the application may have requested children of a range, which are the fractional values in the range. Referring to FIG. 3C, if the query is for the range [0,5] then output device 104 determines all values in the hierarchical correlation information between and including the integers 0 to 5. This may include the integers 1, 2, 3, 4, and 5 in additional to the fractional values of 0.1, 0.2, 0.3, and 0.4 in between the integers 0 to 1. Or, if the children were requested, the fractional values of 0.1, 0.2, 0.3, and 0.4 in between the integers 0 to 1 are returned. The hierarchical correlation information may indicate that there is hierarchical structure information in between the integer values of 0 and 1 in the single-dimensional stream of data.

Referring back to FIG. 5, at 508, output device 104 traverses the single-dimensional stream using the hierarchical correlation information to retrieve markers and objects. For example, the application can retrieve the markers and objects that correspond to the integer values and fractional values. Referring to FIG. 3C, links for the integers and fractional values are used to retrieve characters for the markers and objects of: <li>¶<ol>Item 1</ol>”.

Referring back to FIG. 5, at 510, output device 104 generates a response using the objects and the hierarchical correlation information. For example, the application may generate a response to the query may output the word “Item 1”. Also, using the hierarchical correlation information, output device 104 can add that Item 1 is part of a list, but the hierarchical correlation information is not output, such as the marker “<li>” is not audibly output. Rather, output device 104 interprets the marker to determine that item 1 is part of a list. The interpretation may be made based on recognizing the <li> marker signifies a list.

The hierarchical correlation information allows output device 104 to perform hierarchical operations with the single-dimensional stream. For example, using the fractional numbers and integers, output device 104 can determine the output by traversing the fractional numbers and integers. For example, output device 104 may use the fractional numbers to determine that Item 1 and Item 2 are part of a hierarchical list. Then, output device 104 can output to the user that a list exists. The output may be in a single dimension, such as audio, but output device 104 can include hierarchical structure information in the output in the single dimension, such as stating the list exists.

Output device 104 can also perform other actions using the hierarchical correlation information. For example, output device 104 can navigate the list by using the fractional values to jump from object to object. For example, output device 104 can determine that Item 1 and Item 2 are elements in the list by the existence of fractional values between the integers of 0 and 1. Then, when a user asks for elements of the list, output device 104 can determine that Item 1 and Item 2 are part of the list. Similarly, if a user asks for sub-items of Item 1, output device 104 can use the hierarchical correlation information to determine the sub-items of Item 1 may include hierarchical structure information in the response, such as saying a list includes Item 1 and Item 2. In contrast to the Background, previously the output device would only be able to output the names of Item 1 and Item 2. Output device 104 would not know that there was any hierarchy associated with Item 1 and Item 2 as discussed in the Background. However, using the hierarchical correlation information, output device 104 can determine that Item 1 and Item 2 are part of a list and output a response that indicates Item 1 and Item 2 are part of a list.

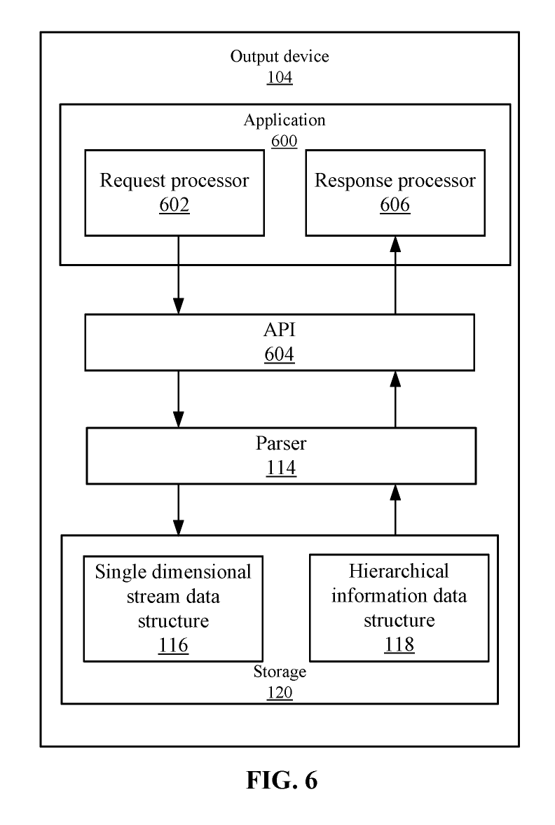

FIG. 6 depicts a more detailed example of output device 104 according to some embodiments. An application 600 may be running on output device 104. Application 600 may include a request processor 602 that processes requests from a user, such as a user may speak a request. Request processor 602 may recognize the words of the request and generate a query that uses API 604. In some embodiments, API 604 follows a specification to access the single-dimensional stream of data stored in single-dimensional stream data structure 116.

Parser 114 may use the hierarchical correlation information from hierarchical information data structure 118 to retrieve the portions of the single-dimensional stream of data from single-dimensional stream data structure 116. Parser 114 embeds the hierarchical correlation information in the retrieved data and send the data back to application 600. A response processor 606 then uses the retrieved data to generate a response to the request. For example, response processor 606 can determine hierarchical structure from markers linked to the fractional numbers to generate output from the single-dimensional stream of data. Then, response processor 606 outputs the response to the request.

Even though a restriction of the API is that a query uses an integer value for the range, output device 104 can use the integer values to retrieve the hierarchical correlation information. The hierarchical correlation information is then used to traverse the single-dimensional stream of data to determine the output. Although the queries are used as integers, because the fractional values are stored in the hierarchical correlation information in between the integer values, output device 104 can determine that there is hierarchical structure information in between the integer values and then interpret that information.

### CONCLUSION

Accordingly, output device 104 can use the hierarchical correlation information to signify a hierarchy in the single-dimensional stream. By including the hierarchical structure information in the single-dimensional stream instead of just the objects, output device 104 can use the hierarchical correlation information to convey the existence of the hierarchical structure information in the single-dimensional stream of data. This allows output device 104 to traverse the hierarchical structure of the single-dimensional stream of data and generate richer responses for the user and allow the user to perform more detailed requests that involve the hierarchical structure of the single-dimensional stream.

Example Computer System

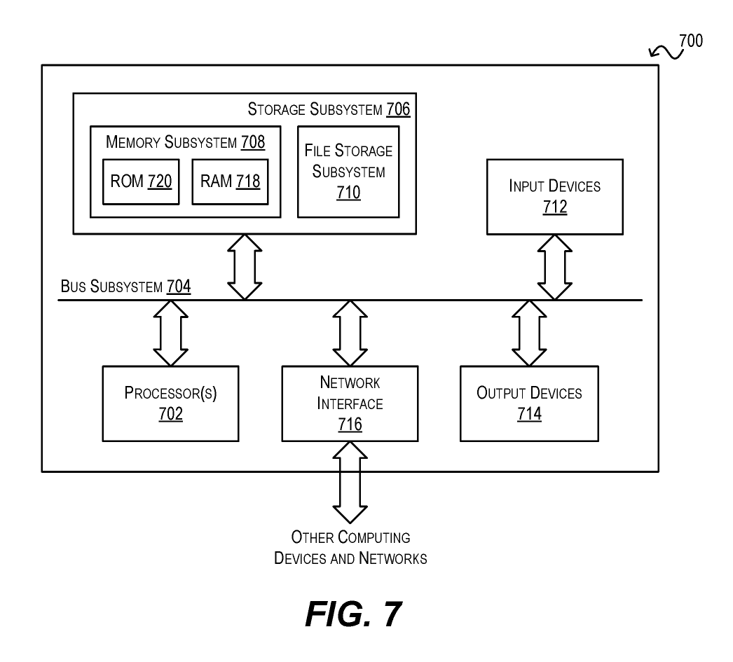

FIG. 7 depicts a simplified block diagram of an example computer system 700 according to certain embodiments. Computer system 700 can be used to implement any of the computing devices, systems, or servers described in the foregoing disclosure. As shown in FIG. 7, computer system 700 includes one or more processors 702 that communicate with a number of peripheral devices via a bus subsystem 704. These peripheral devices include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computer systems or networks. Embodiments of network interface subsystem 716 can include, e.g., an Ethernet card, a Wi-Fi and/or cellular adapter, a modem (telephone, satellite, cable, ISDN, etc.), digital subscriber line (DSL) units, and/or the like.

User interface input devices 712 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 700.

User interface output devices 714 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 700.

Storage subsystem 706 includes a memory subsystem 708 and a file/disk storage subsystem 710. Subsystems 708 and 710 represent non-transitory computer-readable storage media that can store program code and/or data that provide the functionality of embodiments of the present disclosure.

Memory subsystem 708 includes a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and many other configurations having more or fewer components than system 700 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A computer system comprising:
a processor; and
a computer readable storage medium having stored thereon program code that, when executed by the processor, causes the processor to:
receive a request for output in a single dimension;
generate a query for a single-dimensional stream of data based on the request, the query including one or more values, wherein the single-dimensional stream of data is generated from multidimensional data;
access a hierarchical correlation information data structure using the query to determine hierarchical correlation information associated with the one or more values;
use a hierarchical structure from the hierarchical correlation information to generate a response that includes a portion of the single-dimensional stream of data, wherein the hierarchical correlation information signifies the hierarchical structure with respect to the portion of the single-dimensional stream of data; and
output the portion of the single-dimensional stream of data in the single dimension.

2. The computer system of claim 1, wherein the program code further causes the processor to:
receive the multidimensional data; and
parse the multidimensional data to generate the hierarchical correlation information for the single-dimensional stream of data.

3. The computer system of claim 2, wherein the program code further causes the processor to:
store the hierarchical correlation information and the single-dimensional stream of data, wherein values of the hierarchical correlation information are linked to portions of the single-dimensional stream of data.

4. The computer system of claim 3, wherein a first set of values of the hierarchical correlation information is associated with first information in the single-dimensional stream of data that is not output.

5. The computer system of claim 4, wherein the first information is interpreted to determine the hierarchical structure for the portions of the single-dimensional stream of data.

6. The computer system of claim 4, wherein the first information comprise markers that define the hierarchical structure of the multi-dimensional data.

7. The computer system of claim 1, wherein:
the hierarchical correlation information identifies first information in the single-dimensional stream of data that defines the hierarchical structure by fractional numbers, and
the hierarchical correlation information defines second information in the single-dimensional stream of data that can be output by integer numbers.

8. The computer system of claim 7, wherein:
the first information comprises markers that define the hierarchical structure, and
the second information comprises objects that can be output in the single dimension.

9. The computer system of claim 7, wherein a fractional number for the first information is assigned based on an integer value of a neighboring portion of second information in the single-dimensional stream of data.

10. The computer system of claim 7, wherein:
the query includes one or more integer numbers, and
one or more fractional numbers are determined based on the one more integer numbers and used to determine the hierarchical structure.

11. The computer system of claim 10, wherein:
the one or more integer numbers are a range of integer numbers, and
the one or more fractional numbers are fractional numbers within the range of integer numbers.

12. The computer system of claim 10, wherein an interface to the single-dimensional stream of data requires that the query use the one or more integer numbers and not any fractional numbers.

13. The computer system of claim 1, wherein markers in a document object model are included in the single-dimensional stream of data and used to determine the hierarchical structure.

14. The computer system of claim 13, wherein generate the response comprises:
navigate objects that can be output in the single-dimensional stream of data using the hierarchical structure to determine the response.

15. The computer system of claim 1, wherein output the portion of the single-dimensional stream of data comprises:
output information for the hierarchical structure with respect to the portion of the a single-dimensional stream of data.

16. A method comprising:
receiving, by a computing device, a request for output in a single dimension;
generating, by the computing device, a query for a single-dimensional stream of data based on the request, the query including one or more values, wherein the single-dimensional stream of data is generated from multidimensional data;
accessing, by the computing device, a hierarchical correlation information data structure using the query to determine hierarchical correlation information associated with the one or more values;
using, by the computing device, a hierarchical structure from the hierarchical correlation information to generate a response that includes a portion of the single-dimensional stream of data, wherein the hierarchical correlation information signifies the hierarchical structure with respect to the portion of the single-dimensional stream of data; and
outputting, by the computing device, the portion of the single-dimensional stream of data in the single dimension.

17. The method of claim 16, further comprising:
receiving the multidimensional data; and
parsing the multidimensional data to generate the hierarchical correlation information for the single-dimensional stream of data.

18. The method of claim 17, further comprising:
storing the hierarchical correlation information and the single-dimensional stream of data, wherein values of the hierarchical correlation information are linked to portions of the single-dimensional stream of data.

19. The method of claim 16, wherein:
the hierarchical correlation information identifies first information in the single-dimensional stream of data that defines the hierarchical structure by fractional numbers, and
the hierarchical correlation information defines second information in the single-dimensional stream of data that can be output by integer numbers.

20. A computer readable storage medium having stored thereon program code executable by a computer system, the program code causing the computer system to:
receive a request for output in a single dimension;
generate a query for a single-dimensional stream of data based on the request, the query including one or more values, wherein the single-dimensional stream of data is generated from multidimensional data;
access a hierarchical correlation information data structure using the query to determine hierarchical correlation information associated with the one or more values;
use a hierarchical structure from the hierarchical correlation information to generate a response that includes a portion of the single-dimensional stream of data, wherein the hierarchical correlation information signifies the hierarchical structure with respect to the portion of the single-dimensional stream of data; and
output the portion of the single-dimensional stream of data in the single dimension.
